(19) United States
(12) Patent Application Publication
(10) Pub. No.: US 2026/0203683 A1
(43) Pub. Date: Jul. 16, 2026

(54) SOFTWARE EXPERTISE AND ASSOCIATED METADATA TRACKING

(71) Applicant: SCHLUMBERGER TECHNOLOGY CORPORATION, Sugar Land, TX (US)

(72) Inventor: Edo HOEKSTRA, Stavanger (NO)

(21) Appl. No.: 19/138,768

(22) PCT Filed: Dec. 21, 2023
(86) PCT No.: PCT/US2023/085373

§ 371 Date: Jun. 13, 2025

Related U.S. Application Data
(60) Provisional application No. 63/476,443, filed on Dec. 21, 2022.

(51) Int. Cl. G06Q 10/0631; G06F 16/14; G06F 16/16; G06F 16/17; G06Q 10/1053

(52) U.S. Cl. CPC G06Q 10/063112; G06F 16/148; G06F 16/16; G06F 16/1734; G06Q 10/1053

(57) ABSTRACT

A method of logging software usage and tracking user subject matter expertise includes capturing a plurality of software logs from a plurality of extraction and production systems. The method also includes aggregating metadata from the plurality of software logs according to a plurality of categories. The method also includes receiving a search term at a user interface. The method also includes identifying a first user of the plurality of extraction and production systems based upon the search term. The method also includes determining that the first user has an expertise in a first of the categories in response to the metadata showing that the first user has spent more than a first predetermined amount of time working on files associated with the first category, or created or modified more than a first predetermined number of the files associated with the first category.

### CROSS-REFERENCE TO RELATED APPLICATIONS

This patent application claims priority to U.S. Provisional Ser. No. 63/476,443, filed on Dec. 21, 2022, the entirety of which is incorporated by reference herein.

### BACKGROUND

Subject matter experts can build up years of expertise as they work on petrotechnical challenges in the extraction and production (E&P) industry. These subject matter experts may build up knowledge, insights, and domain expertise in different petrotechnical domains, in different geological environments, in different geopolitical and geographical settings, and across single or multiple subsurface interpretation, modeling, simulation, and optimization settings.

However, this information is not consistently captured and not collected centrally. This may lead to increased resources (e.g., time, money, processing, etc.) being used to capture, collect, and process the information. Further, corporations want to understand the skills they have in-house and be able to identify the right expert for a given project. Yet further, individuals with expertise may wish to show off their professional achievements.

### SUMMARY

According to various embodiments, a method of logging software usage and tracking user subject matter expertise is presented. The method includes: capturing a plurality of software logs from a plurality of extraction and production systems; aggregating metadata from the plurality of software logs according to a plurality of categories; receiving a search term at a user interface; performing a search according to the search term, where a search result including an identification of a user of at least one of the plurality of extraction and production systems is determined; and providing the identification of the user of at least one of the plurality of extraction and production systems.

Various optional features of the above embodiments include the following. The capturing may include acquiring a software log by way of an application program interface (API). The plurality of categories may include at least one of: extraction and production system type, input data type, output data type, geographic area, geological environment, or collaborator. The method may further include determining an amount of time the user has spent in association with an attribute in at least one of the categories. The aggregating metadata may include storing representations of users, associated attributes, and associated times. The method may further include: automatically determining that the user is associated with a number of attributes in a category that exceeds a predetermined threshold; and associating the user with an indication of expertise in the category; where the providing the identification of the user further includes providing the indication of expertise in the category. The method may further include: automatically determining that the user is associated with an amount of time on an attribute that exceeds a predetermined threshold; and associating the user with an indication of expertise in the attribute; where the providing the identification of the user further includes providing the indication of expertise in the attribute. The method may further include: performing a skill gap analysis, where the skill gap analysis provides an identification of a second user that has a deficiency associated with one of a category or an attribute; and providing the identification of the second user to one of a training or hiring process. A consolidated data store that associates extraction and production system users with metadata in each of the categories may be produced. The performing the search may include performing the search of the consolidated data store.

According to various embodiments, a system for logging software usage and tracking user subject matter expertise is presented. The system includes and electronic processor and persistent memory storing instructions that, when executed by the electronic processor, configure the electronic processor to perform actions including: capturing a plurality of software logs from a plurality of extraction and production systems; aggregating metadata from the plurality of software logs according to a plurality of categories; receiving a search term at a user interface; performing a search according to the search term, where a search result including an identification of a user of at least one of the plurality of extraction and production systems is determined; and providing the identification of the user of at least one of the plurality of extraction and production systems.

Various optional features of the above embodiments include the following. The capturing may include acquiring a software log by way of an application program interface (API). The plurality of categories may include at least one of: extraction and production system type, input data type, output data type, geographic area, geological environment, or collaborator. The actions may further include determining an amount of time the user has spent in association with an attribute in at least one of the categories. The aggregating metadata may include storing representations of users, associated attributes, and associated times. The actions may further include: automatically determining that the user is associated with a number of attributes in a category that exceeds a predetermined threshold; and associating the user with an indication of expertise in the category; where the providing the identification of the user further includes providing the indication of expertise in the category. The actions may further include: automatically determining that the user is associated with an amount of time on an attribute that exceeds a predetermined threshold; and associating the user with an indication of expertise in the attribute; where the providing the identification of the user further includes providing the indication of expertise in the attribute. The actions may further include: performing a skill gap analysis, where the skill gap analysis provides an identification of a second user that has a deficiency associated with one of a category or an attribute; and providing the identification of the second user to one of a training or hiring process. The system may further include a consolidated data store that associates extraction and production system users with metadata in each of the categories. The performing the search may include performing the search of the consolidated data store.

A method of logging software usage and tracking user subject matter expertise is also disclosed. The method includes capturing a plurality of software logs from a plurality of extraction and production systems. The method also includes aggregating metadata from the plurality of software logs according to a plurality of categories. The method also includes receiving a search term at a user interface. The method also includes identifying a first user of the plurality of extraction and production systems based upon the search term. The method also includes determining that the first user has an expertise in a first of the categories in response to the metadata showing that the first user has spent more than a first predetermined amount of time working on files associated with the first category, or created or modified more than a first predetermined number of the files associated with the first category.

A computing system is also disclosed. The computing system includes one or more processors and a memory system. The memory system includes one or more non-transitory computer-readable media storing instructions that, when executed by at least one of the one or more processors, cause the computing system to perform operations. The operations include capturing a plurality of software logs from a plurality of extraction and production systems. The operations also include aggregating metadata from the plurality of software logs according to a plurality of categories. Each category includes one or more attributes. The operations also include receiving a search term at a user interface. The operations also include identifying a first user of the plurality of extraction and production systems based upon the search term. The operations also include determining that the first user has an expertise in a first of the categories in response to the metadata showing that the first user has spent more than a first predetermined amount of time working on files associated with the first category, and created or modified more than a first predetermined number of the files associated with the first category. The operations also include determining that the first user has an expertise in a first of the attributes of the first category in response to the metadata showing that the first user has spent more than a second predetermined amount of time working on files associated with the first attribute, and created more than a second predetermined number of the files associated with the first attribute. The operations also include displaying the identification of the first user, the expertise in the first category, and the expertise in the first attribute for use in a hiring process or to contact the first user to request expert help related to the first category and the first attribute.

A non-transitory computer-readable medium is also disclosed. The medium stores instructions that, when executed by one or more processors of a computing system, cause the computing system to perform operations. The operations include capturing a plurality of software logs from a plurality of extraction and production systems. The software logs are captured by an application program interface (API). The operations also include aggregating metadata from the plurality of software logs according to a plurality of categories. The categories include at least one of: extraction and production system types, input data types, output data types, geographic areas, geological environments, collaborators, and workflows. The workflows include at least one of: seismic interpretation, 3D model building, reservoir modeling, reservoir simulation, production engineering, and drilling, wherein each category comprises one or more attributes. The one or more attributes include at least one of: porosity, permeability, flow, temperature, pressure, velocity, geological time, geological depth, and facies. The operations also include receiving a search term at a user interface. The operations also include identifying a first user and a second user of the plurality of extraction and production systems based upon the search term. The operations also include determining that the first user has an expertise in a first of the categories in response to the metadata showing that the first user has spent more than a first predetermined amount of time working on files associated with the first category, and created or modified more than a first predetermined number of the files associated with the first category. The files associated with the first category have a verified accuracy within a first accuracy threshold. The operations also include determining that the first user has an expertise in a first of the attributes of the first category in response to the metadata showing that the first user has spent more than a second predetermined amount of time working on files associated with the first attribute, and created more than a second predetermined number of the files associated with the first attribute. The files associated with the first attribute have a verified accuracy within a second accuracy threshold. The operations also include determining that the second user has a lack of expertise in a second of the categories in response to the metadata showing that the second user has spent less than the first predetermined amount of time working on files associated with the second category, and created or modified less than the first predetermined number of the files associated with the second category. The files associated with the second category have a verified accuracy outside of the first accuracy threshold. The operations also include determining that the second user has a lack expertise in a second of the attributes of the second category in response to the metadata showing that the second user has spent less than the second predetermined amount of time working on files associated with the second attribute, and created less than the second predetermined number of the files associated with the second attribute. The files associated with the second attribute have a verified accuracy outside of the second accuracy threshold. The operations also include creating or updating a consolidated data store that includes an identification of the first user, the expertise in the first category, and the expertise in the first attribute. The consolidated data store also includes an identification of the second user, the lack of expertise in the second category, and the lack of expertise in the second attribute. The operations also include displaying the identification of the first user, the expertise in the first category, and the expertise in the first attribute for use in a hiring process or to contact the first user to request expert help related to the first category and the first attribute. The operations also include displaying the identification of the second user, the lack of expertise in the second category, and the lack of expertise in the second attribute for use in a training process.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 is a schematic diagram of a system according to an embodiment.

FIG. 3 is a flowchart illustrating a computer-implemented method of logging software usage and tracking user subject matter expertise, according to an embodiment.

FIG. 4 is a flowchart illustrating another computer-implemented method of logging software usage and tracking user subject matter expertise, according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Subject matter experts (including, but not limited to, petrophysicists, geophysicists, geologists, modelers, reservoir engineers, drilling engineers, production engineers, and data managers) can accumulate expertise as they work in the E&P industry. Although the E&P industry is used as an example, the systems and methods described herein may also be applied to other types of subject matter experts in other industries (e.g., outside of the E&P industry). These subject matter experts may build up knowledge, insights, and domain expertise in different petrotechnical domains, in different geological environments, in different geopolitical and geographical settings, and across single or multiple subsurface interpretation, modeling, simulation, and optimization settings. For example, E&P subject matter experts can accumulate expertise in various production systems and their software, input data types, output data types, geographic areas, and geological environments. Further, E&P subject matter experts can accumulate experience working with various collaborators.

As E&P subject matter experts perform their work with various software platforms, input data types, output data types, geographic areas, geological environments, and collaborators, various embodiments described herein build up a corpus of data where the subject matter expert is associated to his or her activities and/or collaborators. According to various embodiments, the amount of time (e.g., cumulative actual usage platform time or days since start of platform usage) may be tracked.

According to various embodiments, any user can search for a subject matter expert by entering one or more search terms characterizing the sought-after expertise. Various embodiments may return an identification of a matching subject matter expert.

Various embodiments may automatically (e.g., periodically, such as monthly) search the corpus of data to identify individual subject matter expertise milestones for individuals with expertise included within the corpus of data in the database (e.g., based on an amount of activity in a certain area, domain, or activity). Such milestones may be represented as badges, achievements, or other skill level representations in respective search results that identify such individuals.

Various embodiments may perform skill gap analyses of the corpus of data relative to one or more individuals to identify a lack of expertise in any, or any combination of, software platforms, input data types, output data types, geographic areas, and/or geological environments. The results of such analysis may be automatically input to a training or hiring program.

These and other features and advantages are shown and described herein in reference to the drawings presently.

### System Overview

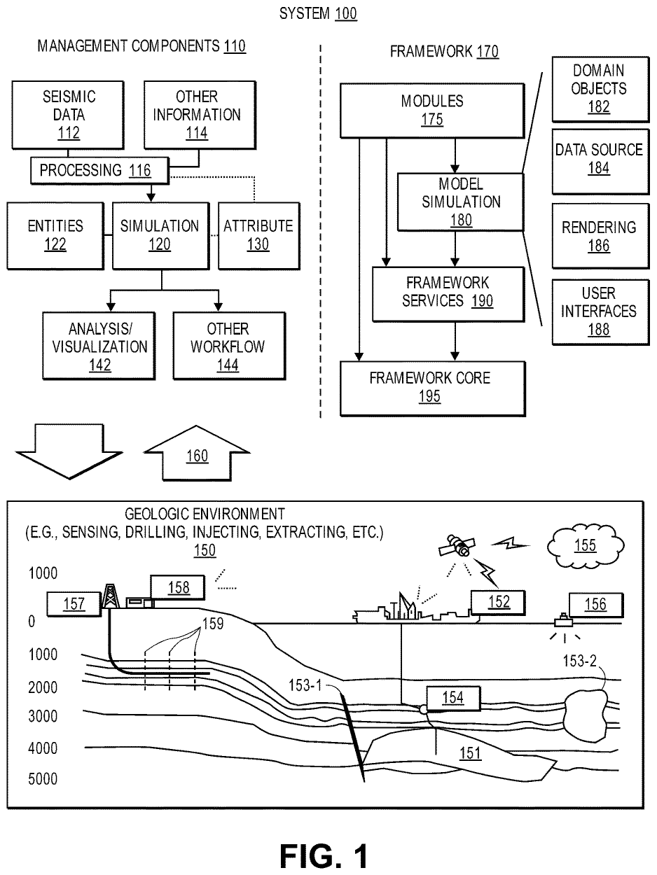

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### E&P System

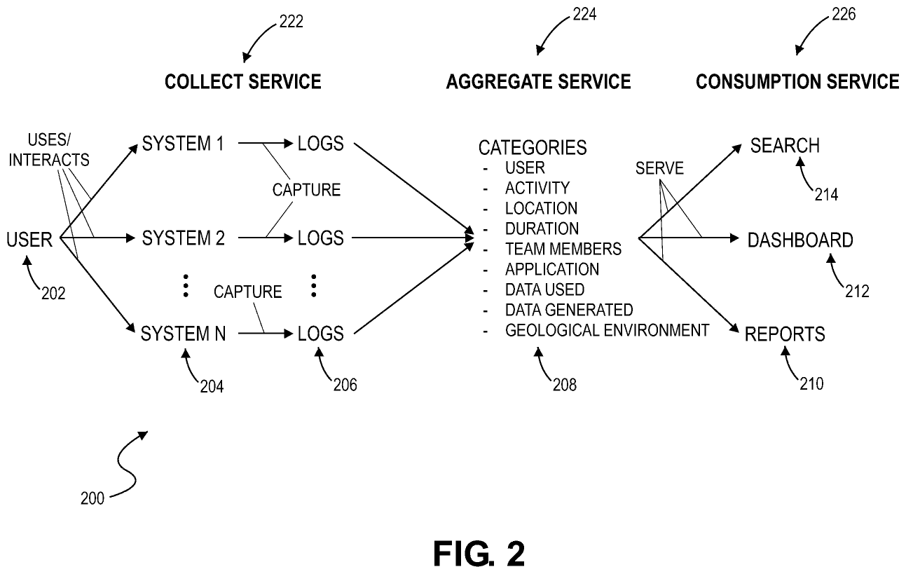

FIG. 2 is a schematic diagram of a system 200, according to various embodiments. The system 200 may be implemented using a programmed computer that includes or is in communication with a plurality of E&P software platforms. Examples of such E&P platforms include any of the management components 110 and/or any framework 170 (e.g., model simulation layer 180, framework services layer 190, framework core layer 195, modules layer 175) as shown and described herein in reference to FIG. 1. Such E&P software platforms may be implemented in one or more computer systems 204. A user 202 may use one or more such E&P software platforms. The system 200 may generate and maintain a corpus of data regarding user subject matter expertise, as described presently.

The system 200 may be secure and compliant with legal frameworks, such as, by way of non-limiting examples, for the handling of personally identifying information (PII) under the European Union's General Data Protection Regulation (GDPR), the United States'Health Insurance Portability and Accountability Act (HIPPA), and/or California's California Privacy Rights Act. The corpus of data may be generated and/or stored within a customer environment so as to shield sensitive data contained therein.

The system 200 includes a collect service 222, which captures logs 206 for the usage of the E&P software platforms on the computer systems 204. Such logs 206 may include metadata representing attributes (e.g., specific instances) of any, or any combination, of information in any of the following categories. A first category includes administrative information, such as user identification, start time and date, stop time and date, etc. A second category includes software information, such as, software platform identification and software platform type (e.g., E&P software platform, wellbore software platform, subsurface data platform, etc.). A third category includes data information, such as input data type (e.g., wellbore data, logs, completion data, reservoir model data, facilities data, seismic data, such as from the seismic data component 112, reflection seismic data, shear wave seismic data, any data from the data source 184, any other information from the other information component 114, etc.), and output data type (e.g., production data, flow data, material data, quantity data, reservoir model data, facilities data, completion data, projects, etc.). A fourth category includes geographic and geological data, such as geographic area (e.g., Nigeria offshore, Gulf offshore, Alaska north slope, etc.), and geological environments (e.g., fluvial depositional, lacustrine depositional, marine, continental, geologic environment 150, etc.). A fifth category includes personnel, such as team members (e.g., as explicitly identified).

The system 200 also includes an aggregate service 224, which aggregates metadata from the logs 206 according to categories 208 to generate and maintain a corpus of metadata (e.g., a consolidated data store), which may include subject matter profiles. Example categories 208 can include any, or any combination, of user, activity, software platform, location, duration (e.g., including start and stop times), team members, input data, output data, and/or geological environment. The aggregate service 224 may associate time (e.g., cumulative time and/or time) since activity start, for each user and attribute combination. In general, the aggregated metadata may include any, or a combination, of: type and duration of applications and processes within the user has been executing, type of data and duration the user has used as input and/or generated with the applications (e.g., seismic, wellbore, logs, completions, reservoir models, facilities), the geographical area the expert has worked in and for how long, the team members the expert has worked with, and/or the amount of time spent performing specific technical tasks.

The aggregate service 224 may perform additional processing on the corpus of metadata. An example of such additional processing is identifying subject matter expertise milestones based on an amount of activity in a certain area, domain, or activity. In some cases, the amount of activity for identifying subject matter expertise milestones can be predetermined. In other cases, the amount of activity for identifying subject matter expertise milestones can be determined on an on-going basis (e.g., by updating the amount of activity with continued use of the system). The amount of activity can be specified according to cumulative time or time since start of the activity. Non-limiting examples include:
Expert A has finalized interpretation on one million seismic traces;
Expert B has created reservoir models in five geological settings;
Expert C has worked over 500 days on reservoir modeling.

Thus, the system 200 may automatically determine that a user is associated with an amount of time on an attribute that exceeds a threshold, or automatically determine that a user is associated with a number of attributes in a category that exceeds a threshold, and associate the user with an indication of expertise in the attribute (e.g., in the subject matter profile for the user), such as a virtual badge or other skill level representation. In some cases, the attribution of expertise for the user can incentivize the user's amount of activity in a certain area, domain, or activity.

The system 200 further includes one or more consumption services 226. The consumption services 226 can include a search service 214, a dashboard service 212, and/or a report service 210. The consumption services 226 may be implemented on web pages or on screens displayed by the system 200, by way of non-limiting examples.

The search service 214 can include a search field into which a user can enter one or more search terms. Each search term can specify one or more attributes in one or more categories. The following are non-limiting example such search terms:
“modeling, fluvial deposition”
“well log, interpretation, Nigeria offshore”
“10 years, reservoir, simulation”

According to some embodiments, the search term may be specified in natural language. Example natural language search terms that correspond to the above examples include:
“find me an expert who worked on modeling of fluvial depositional environments,”
“find me an expert who has performed well log interpretation in Nigeria offshore,”
“find me an expert who has worked more than 10 years with reservoir simulation”.

The search service 214 may also include an API, such that searches may be performed by a bot or other automated process. The search service 214 may perform searches according to user initiation or autonomously (e.g., by a bot or other automated process).

Search results produced by the search service 214 may include milestone(s) for identified subject matter expert. Such milestones may be represented as badges, achievements, or other skill level representations in the search result. According to some embodiments, the search field may accept milestones as search terms.

The dashboard service 212 can include an interface to the system 200. Such an interface can include interface fields, into which an administrator may enter API information for any of the software platforms and/or systems 204. The interface may further include an interface in which an administrator may specify identifications of one or more users of the software platforms and/or systems 204. The interface may further include a configuration options (e.g., for setting up search preferences, expertise milestone, and/or skill gap analyses).

The report service 210 can include an interface into which reports can be requested by a user of the system 200 and/or from which reports can be provided to a user of the system 200. Such reports can include summaries according to any category, attribute, and/or subject matter expertise milestone.

A particular report that can be requested and generated using the report service 210 is a skill gap analysis. The skill gap analysis can be performed relative to one or more, to identify a lack of expertise in any, or any combination of, software platforms, input data types, output data types, geographic areas, and/or geological environments. In some cases, the report service 210 may automatically provide the results of such analysis as input to a training or hiring program.

### Exemplary Method

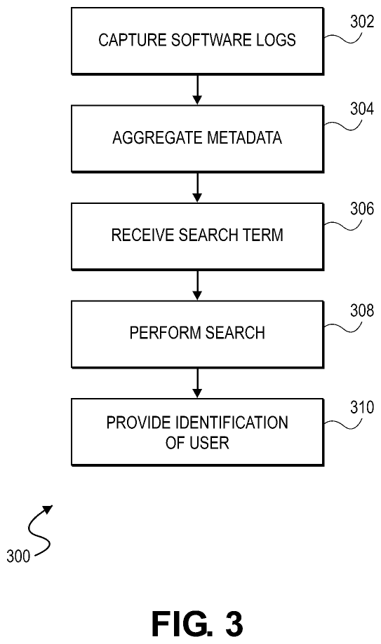

FIG. 3 is a flowchart illustrating a computer-implemented method 300 of logging software usage and tracking user subject matter expertise according to various embodiments. The method 300 may be performed using the system 200 as shown and described herein in reference to FIG. 2. An illustrative order of the method 300 is provided below; however, one or more portions of the method 300 may be performed in a different order, simultaneously, repeated, or omitted.

The method 300 includes capturing a plurality of software logs from a plurality of extraction and production systems, as at 302. The actions of this block may be performed by a collect service, such as the collect service 222, as shown and described herein in reference to FIG. 2.

The method 300 also includes aggregating metadata, as at 304. The metadata may be aggregated from the software logs by an aggregate service, such as the aggregate service 224 as shown and described herein in reference to FIG. 2. For example, the metadata may be aggregated to form a corpus of data (e.g., a consolidated data store) that associates extraction and production system users with metadata in each of a plurality of categories.

The method 300 also includes receiving a search term at a user interface, as at 306. The search term may be received by a search service, such as the search service 214, as shown and described herein in reference to FIG. 2. The search term may be one of a plurality of search terms, and may be specified in natural language.

The method 300 also include performing a search of the consolidated data store according to the search term, as at 308. The actions of this block may be performed as shown and described herein in reference to the search service 214, as shown and described herein in reference to FIG. 2. The performing 308 the search may identify a search result, which may include an identification of a user of at least one of the of extraction and production systems.

The method 300 may also include providing the identification of the user of at least one of the extraction and production systems, as at 310. The actions of this block may be performed as shown and described herein in reference to the search service 214, as shown and described herein in reference to FIG. 2. For example, the identification of the user may be provided on a web page or other screen, and may be provided to a user or to an automated process, such as a bot.

### Exemplary Method

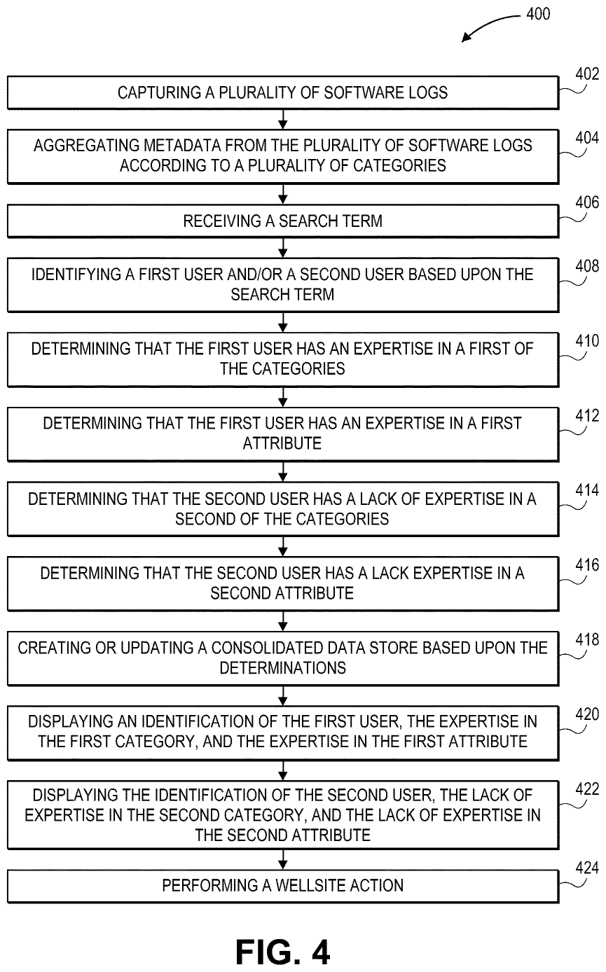

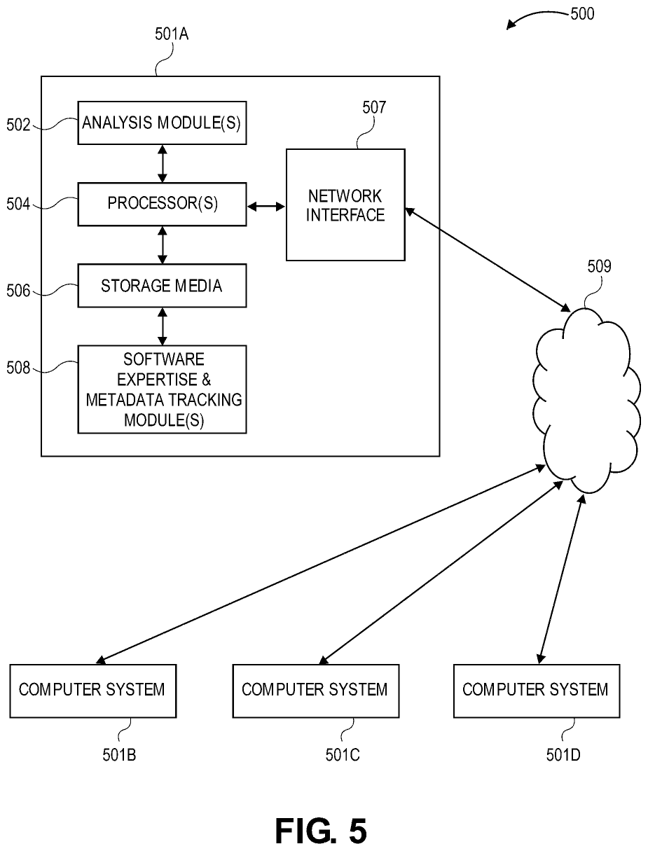

FIG. 4 illustrates a flowchart of a method for logging software usage and tracking user subject matter expertise, according to an embodiment. An illustrative order of the method 400 is provided below; however, one or more portions of the method 400 may be performed in a different order, simultaneously, repeated, or omitted. At least a portion of the method 400 may be performed by a computing system (e.g., computing system 500 as described below in FIG. 5).

The method 400 may include capturing a plurality of software logs, as at 402. The software logs may be captured from a one or more extraction and production systems. The software logs may be captured by an application program interface (API).

The method 400 may also include aggregating metadata from the software logs according to one or more categories, as at 404. The categories may be or include extraction and production system types, input data types, output data types, geographic areas, geological environments, collaborators, workflows, or a combination thereof. The workflows may be or include seismic interpretation, 3D model building, reservoir modeling, reservoir simulation, production engineering, drilling, or a combination thereof. Each category may include one or more attributes. The one or more attributes may be or include porosity, permeability, flow, temperature, pressure, velocity, geological time, geological depth, facies, or a combination thereof.

The method 400 may also include receiving a search term at a user interface, as at 406.

The method 400 may also include identifying a first user and/or a second user of the plurality of extraction and production systems based upon the search term, as at 408.

The method 400 may also include determining that the first user has an expertise in a first of the categories, as at 410. The determination may be in response to the metadata showing that the first user has spent more than a first predetermined amount of time (e.g., 50 hours) working on files associated with the first category. The determination may also or instead be in response to the metadata showing that the first user has created and/or modified more than a first predetermined number of the files (e.g., 50 files) associated with the first category. The files associated with the first category may have a verified accuracy greater than a first accuracy threshold (e.g., >80% when compared with measured data).

The method 400 may also include determining that the first user has an expertise in a first of the attributes, as at 412. The first attribute may be of the first category or a second (e.g., different) category. The determination may be in response to the metadata showing that the first user has spent more than a second predetermined amount of time working on files associated with the first attribute. The second predetermined amount of time may be different (e.g., greater or less) than the first predetermined amount of time. The determination may also or instead be in response to the metadata showing that the first user has created or modified more than a second predetermined number of the files associated with the first attribute. The second predetermined number of files may be different (e.g., greater or less) than the first predetermined number of files. The files associated with the first attribute may have a verified accuracy greater than a second accuracy threshold. The second accuracy threshold may be different (e.g., greater or less) than the first accuracy threshold.

The method 400 may also include determining that the second user has a lack of expertise in the first category or a second of the categories, as at 414. The determination may be in response to the metadata showing that the second user has spent less than the first predetermined amount of time working on files associated with the first and/or second category. The determination may also or instead be in response to the metadata showing that the second user has created or modified less than the first predetermined number of the files associated with the first and/or second category. The files associated with the first and/or second category may have a verified accuracy less than the first accuracy threshold.

The method 400 may also include determining that the second user has a lack expertise in the first attribute or a second of the attributes, as at 416. The first and/or second attribute may be of the first category, the second category, or a third (e.g., different) category. The determination may be in response to the metadata showing that the second user has spent less than the second predetermined amount of time working on files associated with the first and/or second attribute. The determination may also or instead be in response to the metadata showing that the second user has created less than the second predetermined number of the files associated with the first and/or second attribute. The files associated with the first and/or second attribute may have a verified accuracy less than the second accuracy threshold.

The method 400 may also include creating or updating a consolidated data store, as at 418. The data store may include an identification of the first user, the expertise in the first category, the expertise in the first attribute, or a combination thereof. The data store may also or instead include an identification of the second user, the lack of expertise in the second category, the lack of expertise in the second attribute, or a combination thereof.

The method 400 may also include displaying the identification of the first user, the expertise in the first category, and the expertise in the first attribute, as at 420. The display may be for use in a hiring process or to contact the first user to request expert help related to the first category and the first attribute.

The method 400 may also include displaying the identification of the second user, the lack of expertise in the second category, and the lack of expertise in the second attribute, as at 422. The display may be for use in a training process (e.g., to improve proficiency in the second category and/or the second attribute).

The method 400 may also include performing a wellsite action, as at 424. The wellsite action may be based upon the expertise in the first category, the files associated with the first category, the expertise in the first attribute, the files associated with the first attribute, the lack of expertise in the first or second category, the lack of expertise in the first or second attribute, or a combination thereof. The wellsite action may be associated with the first category and/or the first attribute. The wellsite action may be or include generating and/or transmitting a signal (e.g., using a computing system) that causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like. In an example, the wellsite action may be or include adjusting a drilling trajectory in response to input from the first user and/or the files associated with the geological environment and porosity.

### Exemplary Computing System

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more software expertise and associated metadata tracking module(s) 508. In the example of computing system 500, computer system 501A includes the software expertise and associated metadata tracking module 508. In some embodiments, a single software expertise and associated metadata tracking module may be used to perform some aspects of one or more embodiments of the methods disclosed herein. In other embodiments, a plurality of software expertise and associated metadata tracking modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method of logging software usage and tracking user subject matter expertise, the method comprising:
capturing a plurality of software logs from a plurality of extraction and production systems;
aggregating metadata from the plurality of software logs according to a plurality of categories;
receiving a search term at a user interface;
identifying a first user of the plurality of extraction and production systems based upon the search term;
determining that the first user has an expertise in a first of the categories in response to the metadata showing that the first user has:
spent more than a first predetermined amount of time working on files associated with the first category; or
created or modified more than a first predetermined number of the files associated with the first category; and
displaying an identification of the first user and the expertise in the first category.

2. The method of claim 1, wherein the categories comprise at least one of: extraction and production system types, input data types, output data types, geographic areas, geological environments, collaborators, and workflows.

3. The method of claim 2, wherein the workflows comprise at least one of: seismic interpretation, 3D model building, reservoir modeling, reservoir simulation, production engineering, and drilling.

4. The method of claim 1, wherein the first user is determined to have the expertise in the first category in response to the metadata showing that the first user has spent more than the first predetermined amount of time working on files associated with the first category.

5. The method of claim 1, wherein the first user is determined to have the expertise in the first category in response to the metadata showing that the first user has created or modified more than the first predetermined number of the files associated with the first category.

6. The method of claim 1, wherein the files associated with the first category have a verified accuracy greater than a first accuracy threshold.

7. The method of claim 1, wherein each category comprises one or more attributes, and wherein the one or more attributes comprise at least one of: porosity, permeability, flow, temperature, pressure, velocity, geological time, geological depth, and facies.

8. The method of claim 7, further comprising determining that the first user has an expertise in a first of the attributes in response to the metadata showing that the first user has:
spent more than a second predetermined amount of time working on files associated with the first attribute; or
created more than a second predetermined number of the files associated with the first attribute, wherein the files associated with the first attribute have a verified accuracy within a second accuracy threshold.

9. The method of claim 1, further comprising performing a wellsite action in response to input from the first user, wherein the wellsite action is associated with the first category.

10. The method of claim 9, wherein the wellsite action comprises selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.

11. A computing system, comprising:
one or more processors; and
a memory system comprising one or more non-transitory computer-readable media storing instructions that, when executed by at least one of the one or more processors, cause the computing system to perform operations, the operations comprising:
capturing a plurality of software logs from a plurality of extraction and production systems;
aggregating metadata from the plurality of software logs according to a plurality of categories, wherein each category comprises one or more attributes;
receiving a search term at a user interface;
identifying a first user of the plurality of extraction and production systems based upon the search term;
determining that the first user has an expertise in a first of the categories in response to the metadata showing that the first user has:
spent more than a first predetermined amount of time working on files associated with the first category; and
created or modified more than a first predetermined number of the files associated with the first category;
determining that the first user has an expertise in a first of the attributes of the first category in response to the metadata showing that the first user has:
spent more than a second predetermined amount of time working on files associated with the first attribute; and
created more than a second predetermined number of the files associated with the first attribute; and
displaying the identification of the first user, the expertise in the first category, and the expertise in the first attribute for use in a hiring process or to contact the first user to request expert help related to the first category and the first attribute.

12. The computing system of claim 11, wherein the operations further comprise identifying a second user of the plurality of extraction and production systems based upon the search term.

13. The computing system of claim 12, wherein the operations further comprise determining that the second user has a lack of expertise in a second of the categories in response to the metadata showing that the second user has:
spent less than the first predetermined amount of time working on files associated with the second category; and
created or modified less than the first predetermined number of the files associated with the second category, wherein the files associated with the second category have a verified accuracy outside of an accuracy threshold.

14. The computing system of claim 12, wherein the operations further comprise determining that the second user has a lack expertise in a second of the attributes of the second category in response to the metadata showing that the second user has:
spent less than the second predetermined amount of time working on files associated with the second attribute; and
created less than the second predetermined number of the files associated with the second attribute, wherein the files associated with the second attribute have a verified accuracy outside of an accuracy threshold.

15. The computing system of claim 14, wherein the operations further comprise displaying the identification of the second user and the lack of expertise in the second attribute for use in a training process.

16. A non-transitory computer-readable medium storing instructions that, when executed by one or more processors of a computing system, cause the computing system to perform operations, the operations comprising:
capturing a plurality of software logs from a plurality of extraction and production systems, wherein the software logs are captured by an application program interface (API);
aggregating metadata from the plurality of software logs according to a plurality of categories, wherein the categories comprise at least one of: extraction and production system types, input data types, output data types, geographic areas, geological environments, collaborators, and workflows, wherein the workflows comprise at least one of: seismic interpretation, 3D model building, reservoir modeling, reservoir simulation, production engineering, and drilling, wherein each category comprises one or more attributes, and wherein the one or more attributes comprise at least one of: porosity, permeability, flow, temperature, pressure, velocity, geological time, geological depth, and facies;
receiving a search term at a user interface;
identifying a first user and a second user of the plurality of extraction and production systems based upon the search term;
determining that the first user has an expertise in a first of the categories in response to the metadata showing that the first user has:
spent more than a first predetermined amount of time working on files associated with the first category; and
created or modified more than a first predetermined number of the files associated with the first category, wherein the files associated with the first category have a verified accuracy within a first accuracy threshold;
determining that the first user has an expertise in a first of the attributes of the first category in response to the metadata showing that the first user has:
spent more than a second predetermined amount of time working on files associated with the first attribute; and
created more than a second predetermined number of the files associated with the first attribute, wherein the files associated with the first attribute have a verified accuracy within a second accuracy threshold;
determining that the second user has a lack of expertise in a second of the categories in response to the metadata showing that the second user has:
spent less than the first predetermined amount of time working on files associated with the second category; and
created or modified less than the first predetermined number of the files associated with the second category, wherein the files associated with the second category have a verified accuracy outside of the first accuracy threshold;
determining that the second user has a lack expertise in a second of the attributes of the second category in response to the metadata showing that the second user has:
spent less than the second predetermined amount of time working on files associated with the second attribute; and
created less than the second predetermined number of the files associated with the second attribute, wherein the files associated with the second attribute have a verified accuracy outside of the second accuracy threshold;
creating or updating a consolidated data store that includes:
an identification of the first user, the expertise in the first category, and the expertise in the first attribute; and
an identification of the second user, the lack of expertise in the second category, and the lack of expertise in the second attribute;
displaying the identification of the first user, the expertise in the first category, and the expertise in the first attribute for use in a hiring process or to contact the first user to request expert help related to the first category and the first attribute; and
displaying the identification of the second user, the lack of expertise in the second category, and the lack of expertise in the second attribute for use in a training process.

17. The non-transitory computer-readable medium of claim 16, wherein the first predetermined amount of time is different than the second predetermined amount of time.

18. The non-transitory computer-readable medium of claim 16, wherein the first predetermined number of files is different than the second predetermined number of files.

19. The non-transitory computer-readable medium of claim 16, wherein the first accuracy threshold is different than the second accuracy threshold.

20. The non-transitory computer-readable medium of claim 16, wherein the operations further comprise generating and transmitting a signal in response to input from the first user after the first user is identified, wherein the signal causes a wellsite action to occur, and wherein the wellsite action is associated with the first category and the first attribute.
